(19) United States
(12) Patent Application Publication
(10) Pub. No.: US 2009/0026954 A1
(43) Pub. Date: Jan. 29, 2009

(54) Plasma display panel

(76) Inventor: Sang-Hun Jang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/219,496

(22) Filed: Jul. 23, 2008

(30) Foreign Application Priority Data
Jul. 26, 2007 (KR) 10-2007-0075096

(51) Int. Cl. H01J 17/49

(52) U.S. Cl. 313/584

(57) ABSTRACT

A plasma display panel (PDP) includes first and second substrates, a plurality of first and second electrode lines extending along a first direction on the first substrate, the first and second electrode lines having an alternating pattern, a plurality of address electrodes on the second substrate and extending along a second direction, the plurality of address electrodes including bent portions, barrier ribs between the first and second substrates to define a plurality of discharge cells, a plurality of first electrode portions extending from each of the first electrode lines toward discharge cells in two different arrays along the first direction, and a plurality of second electrode portions extending from each of the second electrode lines toward discharge cells in two different arrays along the first direction, the second electrode portions overlapping the bent portions of the address electrodes.

### BACKGROUND OF THE INVENTION

1. Field of the Invention

Embodiments of the present invention relate to a plasma display panel (PDP). More particularly, embodiments of the present invention relate to a PDP having an electrode structure providing high speed addressing at a low voltage.

2. Description of the Related Art

In a conventional PDP, a plurality of electrodes, i.e., address electrodes and pairs of sustain electrodes, may be formed between two facing substrates. In addition, a plurality of discharge cells with discharge gas may be formed between the two facing substrates. Then, when a predetermined discharge pulse is applied to the discharge gas via the electrodes, phosphors in the discharge cells may be excited to emit visible light, so predetermined images may be realized by the PDP.

In order to realize gradation of images in the PDP, a frame may be divided into several different sub-fields with different light emissions. Each of the sub-fields may be divided into a reset section to uniformly generate discharge, an address section to select a discharge cell, and a sustain section to realize gradation of images. During the address section, an address discharge may be generated between the address electrodes and the sustain electrodes to form wall voltage in the discharge cells. The wall voltage may be advantageous during a subsequent sustain discharge in the discharge cells.

A voltage used for the address discharge may be higher than voltage used for the sustain discharge, and may cause a higher power consumption. For example, an increased number of address electrodes with respect to the number of discharge cells, e.g., in display devices having full-HD class resolution, may increase power consumption, so driving efficiency of the PDP may be reduced. Also, reduced line width and pitch of the address electrodes, e.g., in PDPs having high resolution, may decrease address efficiency. Attempts of increasing time allotted for addressing in each sub-field to improve address and driving efficiencies may cause decreased sustain section, so overall image quality, e.g., brightness, may be deteriorated.

### SUMMARY OF THE INVENTION

Embodiments of the present invention are therefore directed to a PDP, which substantially overcomes one or more of the disadvantages of the related art.

It is therefore a feature of embodiments of the present invention to provide a PDP structure having a high-resolution display with high speed addressing at a low voltage.

At least one of the above and other features and advantages of the present invention may be realized by providing a PDP, including first and second substrates spaced apart and facing each other, a plurality of first and second electrode lines extending along a first direction on the first substrate, the first and second electrode lines having an alternating pattern, a plurality of address electrodes on the second substrate and extending along a second direction crossing the first direction, the plurality of address electrodes including bent portions, barrier ribs between the first and second substrates to define a plurality of discharge cells, a plurality of first electrode portions extending from each of the first electrode lines along the second direction, the plurality of first electrode portions of each of the first electrode lines extending toward discharge cells in two different arrays along the first direction, each first electrode portion corresponding to a respective discharge cell, a plurality of second electrode portions extending from each of the second electrode lines along the second direction, the plurality of second electrode portions of each of the second electrode lines extending toward discharge cells in two different arrays along the first direction, each second electrode portion corresponding to a respective discharge cell and first electrode portion, the second electrode portions overlapping the bent portions of the address electrodes, at least one phosphor layer in each discharge cell, and a discharge gas in the discharge cells.

The bent portions of the address electrodes may extend toward the second electrode portions. The bent portions of the address electrodes may have an arc shape. Bent portions of adjacent address electrodes may extend in opposite directions. Each of the second electrode portions may overlap a respective bent portion of an address electrode. A width of a discharge gap between the first and second electrode portions in each discharge cell may be perpendicular to a corresponding address electrode. The PDP may further include branch portions, the branch portions extending from the bent portions over discharge gaps between the first and second electrode portions in the discharge cells. The branch portions may extend from apex points of the bent portions of the address electrodes. Each branch portion may extend along a shortest path between the first and second electrode portions in a respective discharge cell.

The first electrode portions may be arranged in pairs along the first electrode lines, the first electrode portions in each pair extending in opposite directions, and the second electrode portions may be arranged in pairs along the second electrode lines, the second electrode portions in each pair extending in opposite directions. The first electrode portions in each pair may be arranged along a first virtual line and the second electrode portions in each pair may be arranged along a second virtual line, the first and second virtual lines being spaced apart and parallel to each other. The first electrode portions in each pair may be asymmetrical with respect to the first virtual line, and the second electrode portions in each pair may be asymmetrical with respect to the second virtual line. The first and second virtual lines may extend along the second direction. The first electrode portions in each pair may be integral with each other and the second electrode portions in each pair are integral with each other. The first and second electrode portions may extend beyond a center of the discharge cells. Three discharge cells may define a pixel unit, centers of the three discharge cells being arranged in a delta configuration. The barrier ribs may be configured to define the discharge cells in a honey-comb structure. The first and second electrode lines may have a zigzag structure.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded, perspective view of a PDP according to an embodiment of the present invention;

FIG. 2 illustrates a structure of discharge cells of the PDP of FIG. 1;

FIG. 3 illustrates a structure of electrodes of the PDP of FIG. 1; and

FIG. 4 illustrates a structure of electrodes of a PDP according to another embodiment of the present invention.

### DETAILED DESCRIPTION OF THE INVENTION

Korean Patent Application No. 10-2007-0075096, filed on Jul. 26, 2007, in the Korean Intellectual Property Office, and entitled: “Plasma Display Panel,” is incorporated by reference herein in its entirety.

Exemplary embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements and regions may be exaggerated for clarity of illustration. It will also be understood that when an element is referred to as being “on” another element or substrate, it can be directly on the other element or substrate, or intervening elements may also be present. Further, it will be understood that the term “on” can indicate solely a vertical arrangement of one element with respect to another element, and may not indicate a vertical orientation, e.g., a horizontal orientation. In addition, it will also be understood that when an element is referred to as being “between” two elements, it can be the only element between the two elements, or one or more intervening elements may also be present. Like reference numerals refer to like elements throughout.

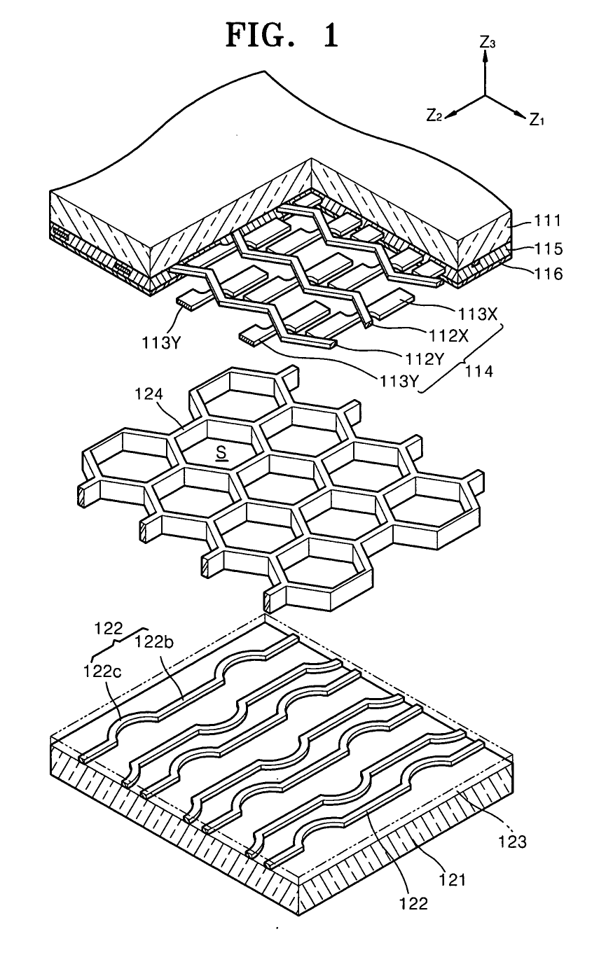

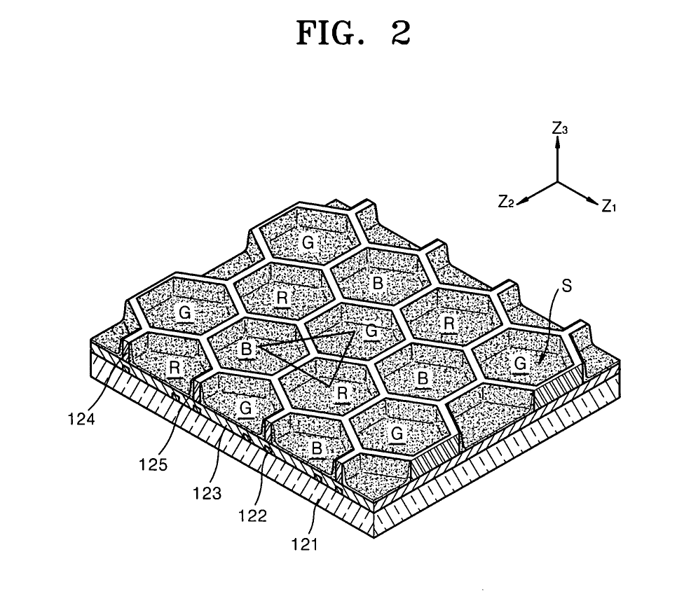

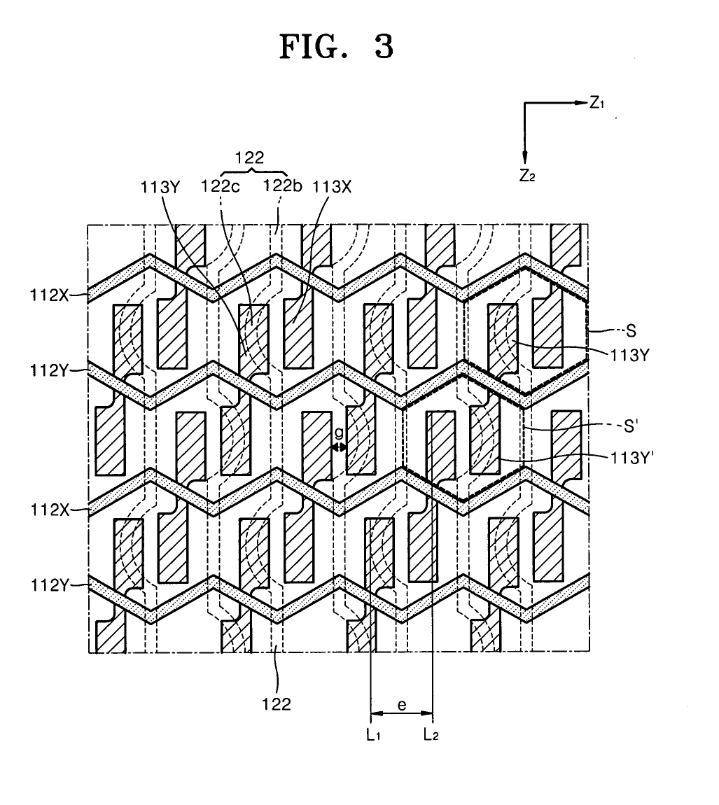

FIG. 1 illustrates an exploded, perspective view of a PDP according to an embodiment of the present invention. The PDP may include first and second substrates 111 and 121 spaced apart from each other, barrier ribs 124, sustain electrodes 114, and address electrodes 122. The first and second substrates 111 and 121 may be attached to each other, so a discharge space may be formed therebetween. The barrier ribs 124, sustain electrodes 114, and address electrodes 122 may be arranged in the discharge space between the first and second substrates 111 and 121. The barrier ribs 124 will be explained in more detail below with reference to FIGS. 1-2, and the sustain electrodes 114 and address electrodes 122 will be explained in more detail below with reference to FIGS. 1 and 3.

As illustrated in FIG. 1, the barrier ribs 124 may be arranged in the discharge space between the first and second substrates 111 and 121 to define a plurality of discharge cells S in a predetermined pattern. The barrier ribs 124 may be arranged in any suitable configuration according to a desired structure of the discharge cells S. For example, the barrier ribs 124 may have an open configuration, e.g., a stripe pattern. In another example, the barrier ribs 124 may have a closed configuration, e.g., a matrix pattern. The discharge cells S may have any suitable cross section, e.g., polygonal, circular, or oval. For example, as illustrated in FIG. 1, the barrier ribs 124 may be arranged to define discharge cells S with hexagonal cross-sections configured in a honeycomb pattern. The discharge cells S may define a display region of the PDP.

More specifically, as illustrated in FIG. 2, the barrier ribs 124 may define a plurality of discharge cells S, so each discharge cell S may be an independent light emitting unit, i.e., a unit optically and electrically separated from other, adjacent or non-adjacent, discharge cells S. Each of the discharge cells S may emit a predetermined color of light, so light emitted from the plurality of the discharge cells S may provide a full-color image according to a color combination of lights emitted from the discharge cells S. A grouping of discharge cells S emitting different colors may define a pixel, i.e., a smallest unit of an image that defines a dot on a color display. For example, three discharge cells S emitting red (R), green (G), and blue (B) lights, respectively, may define a single pixel. The three discharge cells S defining a single pixel may be configured in any suitable arrangement. For example, as illustrated in FIG. 2, three discharge cells S may be arranged so centers thereof form a delta (Δ) in order to define a pixel. In another example, three discharge cells S may be arranged linearly, e.g., in a row, to define a pixel.

A phosphor 125 may be disposed in the discharge cells S. For example, as illustrated in FIG. 2, the phosphor 125 may be coated on inner walls of the discharge cells S, e.g., on sidewalls of the barrier ribs 124 and/or on the second substrate 121, to realize a predetermined light color for each discharge cell S. More specifically, application of voltage to discharge gas in the discharge cells S may generate vacuum ultraviolet (VUV) light therein, which may trigger emission of visible light from the phosphor 125 to form an image. The phosphor 125 may emit light of any suitable color, e.g., R, G, and/or B, to improve the color reproduction.

The sustain electrodes 114 of the PDP may be on the first substrate 111, and may face the second substrate 121, as illustrated in FIG. 1. The sustain electrodes 114 may include pairs of first and second electrode lines 112X and 112Y extending along a first direction, e.g., along the Z₁ axis, and first and second electrode portions 113X and 113Y along a second direction, e.g., along the Z₂ axis. A plurality first electrode portions 113X may correspond to each of the first electrode lines 112X, and a plurality of second electrode portions 113Y may correspond to each of the second electrode lines 112Y.

Referring to FIGS. 1 and 3, the first electrode lines 112X and the second electrode lines 112Y may be alternately arranged on the first substrate 111, e.g., one first electrode line 112X between two second electrode lines 112Y. The first and second electrode lines 112X and 112Y may be formed of a metal having good conductivity, e.g., aluminum, in order to minimize driving loss due to resistance of the first and second electrode lines 112X and 112Y. The first and second electrode lines 112X and 112Y may have any suitable geometrical structure. In particular, the first and second electrode lines 112X and 112Y may have a geometrical structure corresponding to the structure of the barrier ribs 124. In other words, each of the first and second electrode lines 112X and 112Y may overlap a respective portion of the barrier ribs 124, thereby minimizing overlap with the discharge cells S.

For example, the first and second electrode lines 112X and 112Y may completely overlap with the barrier ribs 124, so no overlap may exist between either of the first and second electrode lines 112X and/or 112Y to the discharge cells S. Thus, if the first and second electrode lines 112X and 112Y include opaque material, the minimized overlap between the discharge cells S and either of the first and/or second electrode lines 112X and 112Y may increase light output efficiency from the discharge cells S. For example, as illustrated in FIGS. 1 and 3, the first and second electrode lines 112X and 112Y may have a zigzag structure along the Z₁ axis to correspond to a zigzag structure formed by the honeycomb pattern of the discharge cells S. The first and second electrode lines 112X and 112Y may be connected to an external electrical source (not shown) via terminal regions, i.e., terminals regions of the first electrode lines 112X may be on opposite sides of the display region with respect to terminal regions of the second electrodes lines 112Y, to receive driving signals.

Referring to FIGS. 1 and 3, first and second electrode portions 113X and 113Y may extend along the Z₂ axis, and may be parallel to each other. A plurality of pairs of first electrode portions 113X may be arranged, e.g., in a stripe pattern, along each of the first electrode lines 112X. Similarly, a plurality of pairs of second electrode portions 113Y may be arranged, e.g., in a stripe pattern, along each of the second electrode lines 112Y. The first and second electrode portions 113X and 113Y in each pair may extend away in opposing directions. More specifically, a pair of the first electrode portions 113X may include one first electrode portion 113X extending from a contact point on the first electrode line 112X along the Z₂ axis, and another first electrode portion 113X extending from the same contact point on the first electrode line 112X along the Z₂ axis in an opposite direction with respect to the one first electrode portion 113X. Similarly, a pair of the second electrode portions 113Y may include one second electrode portion 113Y extending from a contact point on the second electrode line 112Y along the Z₂ axis, and another second electrode portion 113Y′ extending from the same contact point on the second electrode line 112Y along the Z₂ axis along an opposite direction with respect to the one second electrode portion 113Y. Accordingly the first and second electrode portions in each pair may be integral with each other, i.e., formed as a single body, and may function as common electrodes for the adjacent discharge cells S.

For example, as illustrated in FIG. 3, a pair of the second electrode portions 113Y may include one second electrode portion 113Y extending along one direction of the Z₂ axis and another second electrode portion 113Y′ extending along an opposite direction of the Z₂ axis. The second electrode portions 113Y and 113Y′ may overlap two different discharge cells S. More specifically, the second electrode portions 113Y and 113Y′ may overlap two adjacent discharge cells S and S′ in different arrays, e.g., rows along the Z₁ axis. The second electrode portions 113Y and 113Y′ may be integral with each other, and may function as common electrodes for the adjacent discharge cells S and S′.

The first and second electrode portions 113X and 113Y may be arranged so one first electrode portion 113X on a first electrode line 112X may be interposed between two adjacent second electrode portions 113Y of an adjacent second electrode line 112Y and parallel thereto, as illustrated in FIG. 3. In other words, the pairs of the first and second electrode portions 113X and 113Y may be arranged in a zigzag formation along extension lines L1 and L2, respectively, as illustrated in FIG. 3. The extension lines L1 and L2 may extend along the second direction, and may be parallel to each other with a predetermined gap e therebetween. Further, the first and second electrode portions 113X and 113Y may be arranged so a pair including one first electrode portion 113X and one second electrode portion 113Y may be formed in each of the discharge cells S. Since each of the first and second electrode portions 113X and 113Y in each discharge cell S is on a different extension line, lengths of the first and second electrode portions 113X and 113Y along the second direction may extend beyond centers of the discharge cells S.

Further, a width of a discharge gap g in each discharge cell S, i.e., a distance measured along the first direction between the first and second electrode portions 113X and 113Y, may be perpendicular to the first and second electrode portions 113X and 113Y. For example, the first electrode portions 113X may function as sustain electrodes, and the second electrode portions 113Y may function as scan electrodes. A predetermined discharge pulse may be input between the first and second electrode portions 113X and 113Y via the first and second electrode lines 112X and 112Y to generate a display discharge through the discharge gap g in the discharge cells S between the first and second electrode portions 113X and 113Y.

The first and second electrode portions 113X and 113Y may have any suitable shape, e.g., a rectangular cross section in the Z₁Z₂ plane. For example, the first and second electrode portions 113X and 113Y may have elongated structures, so a longer side thereof may extend along the Z₂ axis to cross the first and second electrode lines 112X and 112Y. The first and second electrode portions 113X and 113Y may have a predetermined width along the Z₁ axis in order to provide a sufficiently large surface area to the first and second electrode portions 113X and 113Y. A sufficiently large surface area of the second electrode portions 113Y may increase an overlap between the address electrodes 122 and the second electrode portions 113Y, as will be explained in more detail below, so discharge characteristics, e.g., release and diffusion of discharge, may be improved. The discharge surface area of the first and second electrode portions 113X and 113Y may include a light-transparent conductive material, e.g., indium tin oxide (ITO), in order to optimize light transmittance therethrough.

The address electrodes 122, as illustrated in FIGS. 1 and 3, may be arranged on the second substrate 121 along the second direction, i.e., the Z₂ axis. The address electrodes 122 may include bent portions 122c and connecting portions 122b. The bent portions 122c may be curved, e.g., angular or round, and the connecting portions 122b may have linear structures interposed between the bent portions 122c. In particular, the bent portions 122c and the connecting portions 122b may be arranged in an alternating pattern, so each bent portion 122c may be between two connecting portions 122b. The address electrodes 122 may be arranged so the bent portions 122c may overlap the second electrode portions 113Y. Accordingly, the bent portions 122c of the address electrodes 122 may have any suitable structure extending or bent toward the second electrode portions 113Y to form an overlap therewith. For example, the address electrodes 122 may be configured in an alternating configuration, so the bent portions 122c of adjacent address electrodes 122 may extend in opposing directions, i.e., the bends may face opposite directions, in order to overlap respective second electrode portions 113Y.

The address discharge may be mainly generated between the bent portions 122c and the second electrode portions 113Y, and the connecting portions 122b of the address electrodes 122 may transfer signals. The address electrodes 122 may be formed of metal with high electric conductivity in order to minimize driving loss due to the resistance of the address electrodes 122. In addition, as illustrated in FIG. 3, each pair of second electrode portions 113Y crossing a respective second electrode line 112Y, e.g., second electrode portions 113Y and 113Y′, may overlap different discharge cells S and different address electrodes 122, so independent addressing may be applied to each of the discharge cells S, e.g., adjacent discharge cells S and S′. Thus, two different address electrodes 122, which may form an overlapping region with the second electrode portions 113Y and 113Y′, may have bent portions 122c extending in opposite directions.

The address electrodes 122 may overlap the second electrode portions 113Y, and may extend parallel thereto. Arranging the address electrodes 122 and the second electrode portions 113Y as parallel as possible within an allowable range to maximize an overlapping area therebetween may be advantageous to improve address discharge therebetween. In particular, the address electrodes 122 may generate address discharge with the second electrode portions 113Y. An address discharge is an auxiliary discharge preceding a display discharge in order to facilitate release of the display discharge by forming wall charges in predetermined selected discharge cells S. Accordingly, adjusting the directions and structures of the address electrodes 122 and the second electrode portions 113Y with respect to each other may facilitate an increase of the overlapping discharge area between the address electrodes 122 and the second electrode portions 113Y. The overlapping discharge area may be maximized within an allowable range, so a discharge path of the address discharge may be reduced. A reduced discharge path of the address discharge may facilitate display discharge between the first and second electrode portions 113X and 113Y, so high speed addressing at a low driving voltage may be achieved.

Further, when the overlapping discharge area of address discharge is increased, the discharge stability may be increased, as well as an overall image quality of the PDP. In particular, when the overlapping discharge area is increased during address discharge, collision of charged particles with the phosphor 125 on the discharge path may be uniformly distributed on a surface of the phosphor 125, so partial deterioration of the phosphor 125 may be prevented or substantially minimized.

As illustrated in FIG. 1, an upper dielectric layer 115 that buries the first and second electrode lines 113X and 113Y may be formed on the first substrate 111. The upper dielectric layer 115 may protect the first and second electrode lines 112X and 112Y from the discharge, and may induce electron emission to facilitate the discharge. A protection layer 116 may be formed, e.g., an MgO layer, to cover and protect the upper dielectric layer 115. A lower dielectric layer 123 may be formed on the second substrate 121 to bury the address electrodes 122. The lower dielectric layer 123 may protect the address electrodes 122 from being damaged by collisions with charged particles during the discharge. A discharge gas, e.g., a xenon (Xe) gas, a neon (Ne) gas, and/or a krypton (Kr) gas, may be encapsulated in the discharge space between the first substrate 111 and the second substrate 121.

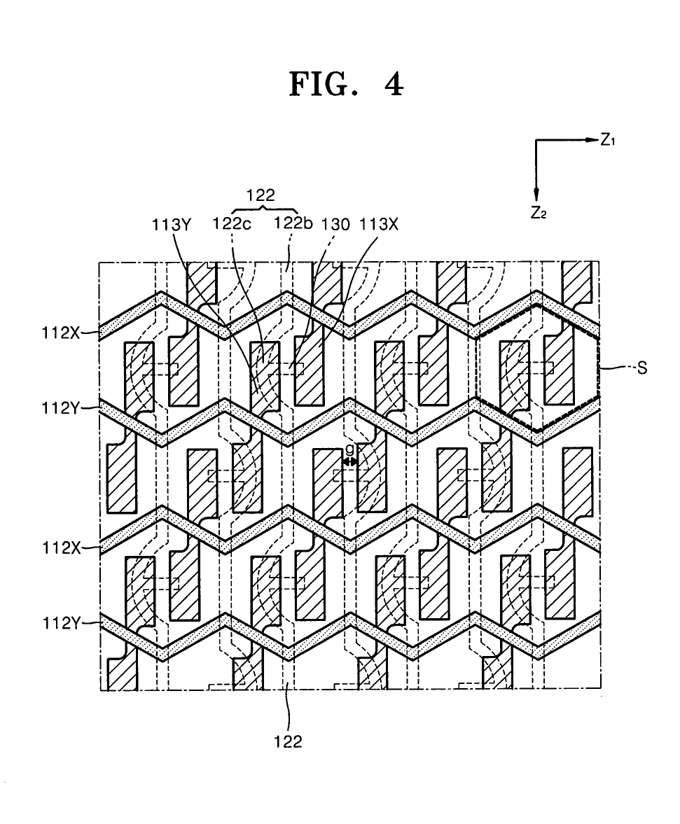

According to another embodiment illustrated in FIG. 4, a PDP may be substantially similar to the PDP described previously with reference to FIGS. 1-3, with the exception of including branch portions 130 on the address electrodes 122. In particular, the branch portions 130 may be formed on the bent portions 122c of the address electrodes 122, and may extend from the bent portion 122c over the discharge gap g in respective discharge cells S. For example, as illustrated in FIG. 4, the branch portions 130 may extend from apex points of the bent portions 122c of the address electrodes 122 over a shortest path between the first and second electrode portions 113X and 113Y in respective discharge cells S, e.g., along the first direction. The branch portions 130 may induce high electric field along the discharge gaps g between the first and second electrode portions 113X and 113Y that perform display discharge between each other, thereby increasing stability of display discharge. The branch portions 130 may be formed as a single body with the address electrodes 122, i.e., integral therewith.

A PDP according to embodiments of the present invention may include second electrode portions, e.g., scan electrode portions, and address electrodes parallel to each other and having an increased overlap therebetween. In particular, the address electrodes may include bent portions along a length direction of the address electrodes, such that bent portions are directed toward and overlap with the second electrode portions. Thus, an overlapping discharge area may be formed and maximized within an allowable range. Accordingly, a discharge path of the address discharge may be minimized to facilitate discharge, thereby enabling high speed addressing at a low voltage. By using the electrode structure of the present invention, the burden of increased power consumption due to a large number of electrodes in a high-resolution display device may be reduced. Also, a decrease in addressing efficiency, which occurs as address electrodes are reduced in pitch, may be prevented.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
first and second substrates spaced apart and facing each other;
a plurality of first and second electrode lines extending along a first direction on the first substrate, the first and second electrode lines having an alternating pattern;
a plurality of address electrodes on the second substrate and extending along a second direction crossing the first direction, the plurality of address electrodes including bent portions;
barrier ribs between the first and second substrates to define a plurality of discharge cells;
a plurality of first electrode portions extending from each of the first electrode lines along the second direction, the plurality of first electrode portions of each of the first electrode lines extending toward discharge cells in two different arrays along the first direction, each first electrode portion corresponding to a respective discharge cell;
a plurality of second electrode portions extending from each of the second electrode lines along the second direction, the plurality of second electrode portions of each of the second electrode lines extending toward discharge cells in two different arrays along the first direction, each second electrode portion corresponding to a respective discharge cell and first electrode portion, the second electrode portions overlapping the bent portions of the address electrodes;
at least one phosphor layer in each discharge cell; and
a discharge gas in the discharge cells.

2. The PDP as claimed in claim 1, wherein the bent portions of the address electrodes extend toward the second electrode portions.

3. The PDP as claimed in claim 2, wherein the bent portions of the address electrodes have an arc shape.

4. The PDP as claimed in claim 2, wherein bent portions of adjacent address electrodes extend in opposite directions.

5. The PDP as claimed in claim 2, wherein each of the second electrode portions overlaps a respective bent portion of an address electrode.

6. The PDP as claimed in claim 1, wherein a width of a discharge gap between the first and second electrode portions in each discharge cell is perpendicular to a corresponding address electrode.

7. The PDP as claimed in claim 1, further comprising branch portions, the branch portions extending from the bent portions over discharge gaps between the first and second electrode portions in the discharge cells.

8. The PDP as claimed in claim 7, wherein the branch portions extend from apex points of the bent portions of the address electrodes.

9. The PDP as claimed in claim 7, wherein each branch portion extends along a shortest path between the first and second electrode portions in a respective discharge cell.

10. The PDP as claimed in claim 1, wherein the first electrode portions are arranged in pairs along the first electrode lines, the first electrode portions in each pair extending in opposite directions, and the second electrode portions are arranged in pairs along the second electrode lines, the second electrode portions in each pair extending in opposite directions.

11. The PDP as claimed in claim 10, wherein the first electrode portions in each pair are arranged along a first virtual line and the second electrode portions in each pair are arranged along a second virtual line, the first and second virtual lines being spaced apart and parallel to each other.

12. The PDP as claimed in claim 11, wherein the first electrode portions in each pair are asymmetrical with respect to the first virtual line, and the second electrode portions in each pair are asymmetrical with respect to the second virtual line.

13. The PDP as claimed in claim 11, wherein the first and second virtual lines extend along the second direction.

14. The PDP as claimed in claim 10, wherein the first electrode portions in each pair are integral with each other and the second electrode portions in each pair are integral with each other.

15. The PDP as claimed in claim 1, wherein the first and second electrode portions extend beyond a center of the discharge cells.

16. The PDP as claimed in claim 1, wherein three discharge cells define a pixel unit, centers of the three discharge cells being arranged in a delta configuration.

17. The PDP as claimed in claim 1, wherein the barrier ribs are configured to define the discharge cells in a honey-comb structure.

18. The PDP as claimed in claim 1, wherein the first and second electrode lines have a zigzag structure.
